(19) United States
(12) Patent Application Publication
(10) Pub. No.: US 2026/0039401 A1
(43) Pub. Date: Feb. 5, 2026

(54) METHOD AND APPARATUS FOR TRANSMITTING AND RECEIVING MEASUREMENT CONFIGURATION INFORMATION, AND DEVICE AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/996,895

(22) PCT Filed: Aug. 3, 2022
(86) PCT No.: PCT/CN2022/110110

§ 371 Date: Jan. 17, 2025

(51) Int. Cl. H04B 17/318; H04B 7/06; H04W 36/00

(52) U.S. Cl. CPC H04B 17/318; H04B 7/0626; H04W 36/0085

(57) ABSTRACT

A method for receiving measurement configuration information is performed by a user equipment and includes: receiving configuration information from a first network device, where the configuration information is configured for configuring measurement and reporting of event trigger category, an event corresponding to the event trigger category is correlated with at least one of: a measurement result of a first-category reference signal of a neighboring cell or a measurement result of a second-category reference signal of the neighboring cell, the first-category reference signal is a disable-able reference signal, and the second-category reference signal is a non-disable-able reference signal.

### CROSS REFERENCE TO RELATED APPLICATIONS

This application is a National Phase of International Application No. PCT/CN2022/110110, filed on Aug. 3, 2022, the entire contents of which are incorporated herein by reference in their entireties.

### TECHNICAL FIELD

The present disclosure relates to the field of radio communication technologies and in particular to methods and apparatuses for transmitting and receiving measurement configuration information, devices and storage mediums.

### BACKGROUND

In the development of the radio communication technologies, how to reduce energy consumption of base stations has become a hot research topic. One method of reducing the energy consumption of the base stations is to dynamically switch spatial units, for example, some antenna units, ports, transceiver chains (TRX chain), beams, panels, reference signals (RSs) and the like. However, dynamically switching the spatial units may lead to change of actually-transmitted reference signals.

In some embodiments, in the Radio Resource Management (RRM) measurements, a network device may configure one or more to-be-measured cells for a user equipment (UE). The to-be-measured cell may be a neighboring cell of the UE, or a neighboring cell and service cell of the UE. The network device may also configure one or more to-be-measured reference signals in each neighboring cell for the user equipment.

### SUMMARY

The present disclosure provides methods and apparatuses for transmitting measurement configuration information, devices and storage mediums.

According a first aspect, there is provided a method for receiving measurement configuration information, which is performed by a user equipment. The method includes: receiving configuration information from a first network device, where the configuration information is configured for configuring measurement and reporting of event trigger category, an event corresponding to the event trigger category is correlated with at least one of: a measurement result of a first-category reference signal of a neighboring cell or a measurement result of a second-category reference signal of the neighboring cell.

In some embodiments, the first-category reference signal is a disable-able reference signal and the second-category reference signal is a non-disable-able reference signal. In some embodiments, the event is at least one of that:

the measurement result of the second-category reference signal of the neighboring cell is better than a measurement result of a reference signal of a primary cell or primary-secondary cell, and a difference between the measurement results is greater than a first offset; the measurement result of the second-category reference signal of the neighboring cell is better than a first threshold; a measurement result of a reference signal of a service cell is worse than a second threshold, and the measurement result of the second-category reference signal of the neighboring cell is better than a third threshold; the measurement result of the second-category reference signal of the neighboring cell is better than a measurement result of a reference signal of a secondary cell, and a difference between the measurement results is greater than a second offset; or the measurement result of the first-category reference signal of the neighboring cell and the measurement result of the second-category reference signal of the neighboring cell are both better than a fourth threshold. In some embodiments, the method further includes:

receiving indication information from the first network device, where the indication information is configured to indicate whether a to-be-measured reference signal of the neighboring cell is the first-category reference signal.

In some embodiments, receiving the indication information from the first network device includes: receiving radio resource management (RRM) measurement configuration information from the first network device, where the RRM measurement configuration information includes the indication information.

In some embodiments, the to-be-measured reference signal is a synchronization signal block (SSB) or a channel state information-reference signal (CSI-RS).

According to a second aspect, there is provided a method for transmitting measurement configuration information, which is performed by a first network device. The method includes: transmitting configuration information to a user equipment, where the configuration information is configured for configuring measurement and reporting of event trigger category, an event corresponding to the event trigger category is correlated with at least one of: a measurement result of a first-category reference signal of a neighboring cell or a measurement result of a second-category reference signal of the neighboring cell, the first-category reference signal is a disable-able reference signal, and the second-category reference signal is a non-disable-able reference signal.

In some embodiments, the event is at least one of that:
the measurement result of the second-category reference signal of the neighboring cell is better than a measurement result of a reference signal of a primary cell or primary-secondary cell, and a difference between the measurement results is greater than a first offset; the measurement result of the second-category reference signal of the neighboring cell is better than a first threshold; a measurement result of a reference signal of a service cell is worse than a second threshold, and the measurement result of the second-category reference signal of the neighboring cell is better than a third threshold; the measurement result of the second-category reference signal of the neighboring cell is better than a measurement result of a reference signal of a secondary cell, and a difference between the measurement results is greater than a second offset; or the measurement result of the first-category reference signal of the neighboring cell and the measurement result of the second-category reference signal of the neighboring cell are both better than a fourth threshold.

In some embodiments, the method further includes:
transmitting indication information to the user equipment, where the indication information is configured to indicate whether a to-be-measured reference signal of the neighboring cell is the first-category reference signal.

In some embodiments, transmitting the indication information to the user equipment includes:
transmitting Radio Resource Management (RRM) measurement configuration information to the user equipment, where the RRM measurement configuration information includes the indication information.

In some embodiments, the method further includes:
receiving notification information from a second network device, where the notification information is configured to indicate whether a to-be-measured reference signal transmitted by the second network device for RRM-measurement by a user equipment in a cell corresponding to the first network device is the first-category reference signal.

In some embodiments, the to-be-measured reference signal is a synchronization signal block (SSB) or a channel state information-reference signal (CSI-RS).

According to a third aspect, there is provided an electronic device, which includes a processor and a memory, where the memory is configured to store computer programs; and the processor is configured to execute the computer programs to perform the first aspect or any possible design of the first aspect.

According to a fourth aspect, there is provided a communication device, which includes a processor and a memory, where the memory is configured to store computer programs; and the processor is configured to execute the computer programs to perform the second aspect or any possible design of the second aspect.

According to a fifth aspect, there is provided a non-transitory computer readable storage medium, storing instructions; where the instructions, when executed by a processor, cause the processor to perform the first aspect or any possible design of the first aspect.

According to a sixth aspect, there is provided a computer readable storage medium, storing instructions; where the instructions, when executed by a processor, cause the processor to perform the second aspect or any possible design of the second aspect.

### BRIEF DESCRIPTION OF THE DRAWINGS

The drawings described herein are configured to provide further understanding of the embodiments of the present disclosure and constitute a part of the present disclosure. The illustrative examples of the embodiments of the present disclosure and its descriptions are configured to interpret the embodiments of the present disclosure and do not constitute any improper limitation to the embodiments of the present disclosure.

The accompanying drawings, which are incorporated in and constitute a part of the present description, illustrate examples consistent with the embodiments of the present disclosure and serve to explain the principles of the embodiments of the present disclosure together with the description.

FIG. 1 is an architecture schematic diagram illustrating a radio communication system according to an embodiment of the present disclosure.

FIG. 2 is a flowchart illustrating a method of transmitting configuration information according to an embodiment of the present disclosure.

FIG. 3 is a flowchart illustrating a method of receiving configuration information according to an embodiment of the present disclosure.

FIG. 4 is a flowchart illustrating a method of receiving configuration information according to an embodiment of the present disclosure.

FIG. 5 is a flowchart illustrating a method of receiving configuration information according to an embodiment of the present disclosure.

FIG. 6 is a flowchart illustrating a method of transmitting configuration information according to an embodiment of the present disclosure.

FIG. 7 is a flowchart illustrating a method of transmitting configuration information according to an embodiment of the present disclosure.

FIG. 8 is a flowchart illustrating a method of transmitting configuration information according to an embodiment of the present disclosure.

FIG. 9 is a structural diagram illustrating an apparatus for receiving configuration information according to an embodiment of the present disclosure.

FIG. 10 is a structural diagram illustrating an apparatus for receiving configuration information according to an embodiment of the present disclosure.

FIG. 11 is a structural diagram illustrating an apparatus for transmitting configuration information according to an embodiment of the present disclosure.

FIG. 12 is a structural diagram illustrating an apparatus for transmitting configuration information according to an embodiment of the present disclosure.

### DETAILED DESCRIPTION OF THE EMBODIMENTS

The embodiments of the present disclosure will be further described below in combination with drawings and specific implementations.

Exemplary embodiments will be described in details herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the embodiments of the present disclosure are for the purpose of describing particular embodiments only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any or all possible combinations of one or more of the associated listed items.

It should be understood that, although the terms “first,” “second,” “third,” and the like may be used in the present disclosure to describe various information, such information should not be limited to these terms. These terms are only configured to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

The embodiments of the present disclosure will be described below in details with the examples thereof shown in the accompanying drawings, and the same or similar reference numerals represent same or similar elements throughout the specification. The embodiments described hereunder by referring to the drawings are illustrative and intended to interpret the present disclosure and shall not be understood as limiting of the present disclosure.

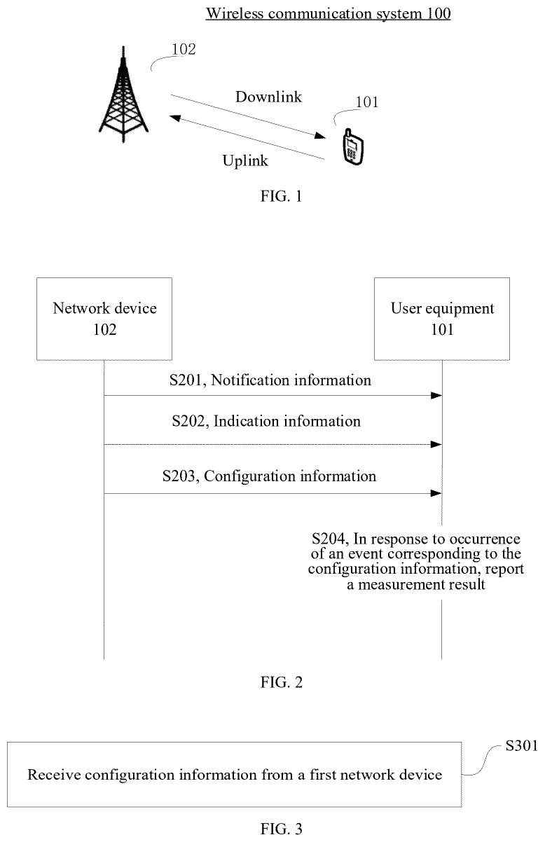

As shown in FIG. 1, an embodiment of the present disclosure provides a method of transmitting configuration information, which can be applied to a wireless communication system 100. The wireless communication system 100 can include a user equipment 101 and a network device 102. The user equipment 101 is configured to support carrier aggregation and can be connected to multiple carrier units of the network device 102, for example, to one primary carrier unit and one or more secondary carrier units.

It should be understood that the wireless communication system 100 can be applied to not only low-frequency scenarios but also high-frequency scenarios. The application scenarios of the wireless communication system 100 include but not limited to long term evolution (LTE) system, LTE frequency division duplex (FDD) system, LTE time division duplex (TDD) system, worldwide interoperability for micro wave access (WiMAX) communication system, cloud radio access network (CRAN) system, future 5th-Generation (5G) system, new radio (NR) communication system or future evolved public land mobile network (PLMN) system and the like.

The user equipment 101 may be a terminal, an access terminal, a terminal unit, a terminal station, a mobile station (MS), a remote station, a remote terminal, a mobile terminal, a wireless communication device, a terminal agency or a terminal device or the like. The user equipment 101 may have wireless transmitting and receiving function to communicate (e.g. wirelessly communicate) with one or more network devices in one or more communication systems and accept a network service provided by the network device. The network device herein includes but not limited to the network device 102 shown.

The UE 101 may be a cell phone, a cordless telephone, a session initiation protocol (SIP) telephone, a wireless local loop (WLL) station, a personal digital assistant (PDA) device, a palm-held device or computing device having wireless communication function, or another processing device connected to wireless modem, a vehicle-mounted device, a wearable device, a terminal device in future 5G network or a terminal device in a future evolved PLMN network or the like.

The network device 102 may be an access network device (or referred to as access network site). The access network device refers to a device providing network access function, such as a radio access network (RAN) base station and the like. The network device 102 may specifically include a base station (BS) or include a base station and a radio resource management device for controlling the base station and the like. The network device 102 may also include a relay station (relay device), an access point, a base station in future 5G network, a base station in future evolved PLMN network or an NR base station or the like. The network device 102 may be a wearable device or vehicle-mounted device. The network device 102 may also be a communication chip having a communication module.

For example, the network device 102 may include but not limited to a next-generation base station (gnodeB, gNB) in 5G, an evolved node B (eNB) in LTE system, a radio network controller (RNC), a node B (NB) in WCDMA system, a radio controller in CRAN system, a base station controller (BSC), a base transceiver station (BTS) in GSM system or CDMA system, a home base station (e.g. home evolved nodeB or home node B, HNB), a baseband unit (BBU), a transmitting and receiving point (TRP), a transmitting point (TP) or a mobile exchange center or the like.

In a Radio Resource Management (RRM) measurement result reporting mechanism, an event trigger can be employed. Multiple events related to measurement result can be predefined in a protocol and the network device can configure one or more event trigger reporting configurations for the user equipment. When the user equipment determines occurrence of a trigger event, a corresponding measurement result can be reported.

For example, the UE1 is in cell0 and receives two reporting configurations: one is reportconfig1 and the other is reportconfig2.

In the reportconfig1, the measurement object is an SSB of the cell1 and an SSB of the cell2 and the trigger condition is Event 1 (the event may correspond to one threshold).

In the reportconfig2, the measurement object is an SSB of the cell1 and an SSB of the cell2 and the trigger condition is Event 2 (the event may correspond to another threshold).

When the measurement result of the UE for the SSB of the cell1 satisfies Event 1, the measurement result of the cell1 is reported in a report associated with the reportconfig1.

When the measurement result of the UE for the SSB of the cell2 satisfies Event 2, the measurement result of the cell2 is reported in a report associated with the reportconfig2.

If a to-be-measured reference signal of a neighboring cell can be dynamically disabled, it means the neighboring cell possibly desires to achieve energy saving effect by dynamically disabling the reference signal. Therefore, these dynamically-disable-able reference signals are usually not used as optimal targets the user equipment switches to. Furthermore, even if the measurement result of the dynamically-disable-able reference signal in the neighboring cell is better, the user equipment may not desire report relevant measurement result.

When the to-be-measured reference signals of the neighboring cell can be dynamically disabled, valid reporting of measurement results may be affected.

In an embodiment of the present disclosure, the first-category reference signal is a disable-able reference signal and the second-category reference signal is a non-disable-able reference signal. The second-category signal can also be interpreted as reference signal other than the first-category reference signal in the to-be-measured signals. The network device can label the first-category reference signal and the second-category reference signal respectively or only label the first-category reference signal. When only the first-category reference signal is labeled, the user equipment can determine other unlabeled reference signals as the second-category reference signal based on the labeled first-category reference signal. An embodiment of the present disclosure provides a method for transmitting measurement configuration information. In the method, a first network device and a second network device manage different cells. For a user equipment under the first network device, the cell under the management of the first network device is a service cell, and the cell under the management of the second network device is a neighboring cell.

FIG. 2 is a flowchart illustrating a method of transmitting a reference signal measurement result according to an exemplary embodiment of the present disclosure. As shown in FIG. 2, the method includes steps S201 to S204.

At step S201, the second network device transmits notification information to the first network device.

The notification information is configured to indicate whether a to-be-measured reference signal transmitted by the second network device for Radio Resource Management (RRM)-measurement by a user equipment in a cell corresponding to the first network device is the first-category reference signal.

In some embodiments, the to-be-measured reference signal is a Synchronization Signal Block (SSB) or Channel State Information-Reference signal (CSI-RS).

After receiving the notification information, the first network device may determine whether the to-be-measured reference signal transmitted by the second network device for RRM-measurement by the user equipment in the cell corresponding to the first network device is the first-category reference signal. A neighboring cell of the user equipment is a cell under the second network device. A cell under the first network device to which the user equipment belongs is a service cell.

At step S202, the first network device transmits indication information to the user equipment.

The indication information is configured to indicate whether a to-be-measured reference signal of the neighboring cell of the user equipment is the first-category reference signal.

In some embodiments, the first network device transmits the indication information to the user equipment, which includes: transmitting RRM measurement configuration information to the user equipment, where the RRM measurement configuration information includes the indication information.

At step S203, the first network device transmits configuration information to the user equipment.

The configuration information is configured for configuring measurement and reporting of event trigger category, and an event corresponding to the event trigger category is correlated with at least one of a measurement result of a first-category reference signal and a measurement result of a second-category reference signal of the neighboring cell.

In some embodiments, the event may be at least one of that:
the measurement result of the second-category reference signal of the neighboring cell is better than a measurement result of reference signal of a primary cell or primary-secondary cell, and a difference between the measurement results is greater than a first offset; the measurement result of the second-category reference signal of the neighboring cell is better than a first threshold; a measurement result of reference signal of the service cell is worse than a second threshold, and the measurement result of the second-category reference signal of the neighboring cell is better than a third threshold; the measurement result of the second-category reference signal of the neighboring cell is better than a measurement result of a reference signal of a secondary cell, and a difference between the measurement results is greater than a second offset; or the measurement result of the first-category reference signal of the neighboring cell and the measurement result of the second-category reference signal of the neighboring cell are both better than a fourth threshold.

The first-category reference signal of the neighboring cell in the event refers to any first-category reference signal in the neighboring cell. When any first-category reference signal in the neighboring cell satisfies the event, an event trigger condition is satisfied. The second-category reference signal of the neighboring cell in the event refers to any second-category reference signal in the neighboring cell. When any second-category reference signal in the neighboring cell satisfies the event, the event trigger condition is satisfied.

In another possible implementation, the first-category reference signal of the neighboring cell in the event refers to all first-category reference signals of the neighboring cell. When all first-category reference signals in the neighboring cell satisfy the event, the event trigger condition is satisfied. It is the same with the second-category reference signal of the neighboring cell in the event.

Each offset and each threshold are a fixed value determined based on the protocol or a value configured by the first network device, which can be modified based on actual use.

The steps S202 and steps S203 are not limited to a specific sequence of firstly performing the step S202 and then the step S203, and therefore can be performed at the same time or performed in a sequence of firstly performing the step S203 and then the step S202.

At step S204, the user equipment reports a measurement result in response to occurrence of an event corresponding to the configuration information.

Reporting the measurement result includes: reporting a measurement result of a reference signal triggering the event.

Descriptions are made below with an example.

### Example 1

The event corresponding to the event trigger category in the configuration information is that: the measurement result of the first-category RS of the neighboring cell and the measurement result of the second-category RS are both better than the fourth threshold.

There are two neighboring cells to be measured by the UE: Cell1 and Cell2.

The first neighboring cell has two to-be-measured RSs respectively referred to as a first to-be-measured RS and a second to-be-measured RS. The first to-be-measured RS is the first-category RS and the second to-be-measured RS is the second-category RS.

The second neighboring cell has two to-be-measured RSs respectively referred to as a third to-be-measured RS and a fourth to-be-measured RS. The third to-be-measured RS is the first-category RS and the fourth to-be-measured RS is the second-category RS.

After the UE measures the first to-be-measured RS, the second to-be-measured RS, the third to-be-measured RS and the fourth to-be-measured RS, when the measurement result of the first to-be-measured RS and the measurement result of the second to-be-measured RS are both better than the fourth threshold, the event is satisfied and the UE reports the measurement result of the first to-be-measured RS and the measurement result of the second to-be-measured RS. When the measurement result of the third to-be-measured RS is better than the fourth threshold and the measurement result of the fourth to-be-measured RS is worse than the fourth threshold at the same time, the event not satisfied and the UE does not report the measurement result of any to-be-measured RS of the second neighboring cell.

From the example, it can be known that, by setting the event corresponding to the trigger category as the fact that the measurement result of the first-category RS and the measurement result of the second-category RS of the neighboring cell are both better than the fourth threshold, the UE can report the measurement result only when the measurement results of all reference signals of one neighboring cell are superior. Since the first-category RS may be dynamically disabled instead of preferentially switching targets, there is less meaning of reporting the measurement result of the first-category RS, which avoids the case in which the measurement result is reported when the measurement result of the first-category RS is superior and the measurement result of the second-category RS is inferior.

### Example 2

The event corresponding to the event trigger category in the configuration information is that: the measurement result of the second-category RS of the neighboring cell is better than the first threshold.

There are two neighboring cells to be measured by the UE: Cell1 and Cell2.

The first neighboring cell has two to-be-measured RSs respectively referred to as first to-be-measured RS and second to-be-measured RS. The first to-be-measured RS is the first-category RS and the second to-be-measured RS is the second-category RS.

The second neighboring cell has two to-be-measured RSs respectively referred to as a third to-be-measured RS and a fourth to-be-measured RS. The third to-be-measured RS is the first-category RS and the fourth to-be-measured RS is the second-category RS.

After the UE measures the first to-be-measured RS, the second to-be-measured RS, the third to-be-measured RS and the fourth to-be-measured RS, when the measurement result of the second to-be-measured RS is better than the fourth threshold, the event is satisfied and the measurement result of the second to-be-measured RS is reported. When the measurement result of the third to-be-measured RS is better than the first threshold and the measurement result of the fourth to-be-measured RS is worse than the first threshold at the same time, the event is not satisfied and the measurement result of any to-be-measured RS of the second neighboring cell is not reported.

From the example, it can be known that, by setting the event corresponding to the trigger category as the fact that the measurement result of the second-category RS of the neighboring cell is better than the first threshold, the UE can report the measurement result only when the measurement results of all the second-category RSs of one neighboring cell are superior. Since the first-category RS may be dynamically disabled instead of preferentially switching targets, there is less meaning of reporting the measurement result of the first-category RS. The method of preferentially guaranteeing the measurement result of the second-category RS is superior without considering the measurement result of the first-category RS avoids unnecessary reporting of the measurement result of the first-first RS.

In the present disclosure, compared with the solution in which a corresponding measurement result is reported when any to-be-measured reference signal satisfies the trigger event without determining whether the to-be-measured reference signal is the first-category reference signal, considering when the to-be-measured reference signal of the neighboring cell is the first-category reference signal, the beam corresponding to the to-be-measured reference signal may be dynamically disabled instead of preferentially switching target, there is less meaning of reporting a corresponding measurement result due to the trigger of the measurement result of the first-category reference signal satisfying the trigger event requirement. By determining the to-be-measured reference signal of the neighboring cell is the first-category reference signal or the second-category reference signal and configuring measurement and reporting of the event trigger category to correlate the event corresponding to the event trigger category with the measurement result of the first-category reference signal and/or the measurement result of the second-category reference signal, unnecessary reporting can be avoided in the circumstance that only the measurement result of the first-category reference signal satisfies the trigger event and the measurement result of the second-category reference signal does not satisfy the trigger event, making the reporting of the measurement result more reasonable and effective.

An embodiment of the present disclosure provides a method for receiving measurement configuration information, which is performed by a user equipment. FIG. 3 is a flowchart illustrating a method of receiving a reference signal measurement result according to an exemplary embodiment of the present disclosure. As shown in FIG. 3, the method includes step S301.

At step S301, configuration information is received from a first network device.

The configuration information is configured for configuring measurement and reporting of event trigger category, and an event corresponding to the event trigger category is correlated with at least one of a measurement result of a first-category reference signal and a measurement result of a second-category reference signal of a neighboring cell.

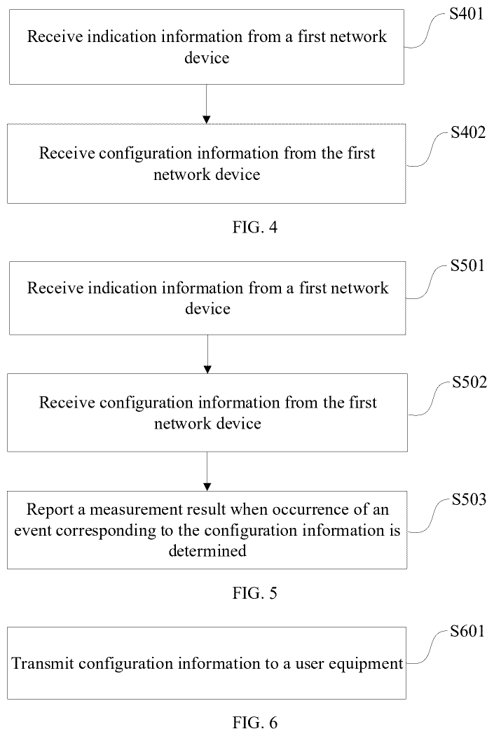

An embodiment of the present disclosure provides a method for receiving measurement configuration information, which is performed by a user equipment. FIG. 4 is a flowchart illustrating a method of receiving a reference signal measurement result according to an exemplary embodiment of the present disclosure. As shown in FIG. 4, the method includes steps S401 to S402.

At step S401, indication information is received from a first network device.

The indication information is configured to indicate whether a to-be-measured reference signal of a neighboring cell of the user equipment is a first-category reference signal.

In some embodiments, receiving the indication information from the first network device includes: receiving RRM measurement configuration information from the first network device, where the RRM measurement configuration information includes the indication information.

In some embodiments, the to-be-measured reference signal is SSB or CSI-RS.

At step S402, configuration information is received from the first network device.

The configuration information is configured for configuring measurement and reporting of event trigger category, and an event corresponding to the event trigger category is correlated with at least one of a measurement result of a first-category reference signal and a measurement result of a second-category reference signal of the neighboring cell.

An embodiment of the present disclosure provides a method for receiving measurement configuration information, which is performed by a user equipment. FIG. 5 is a flowchart illustrating a method of receiving a reference signal measurement result according to an exemplary embodiment of the present disclosure. As shown in FIG. 5, the method includes steps S501 to S503.

At step S501, indication information is received from a first network device.

The indication information is configured to indicate whether a to-be-measured reference signal of a neighboring cell of the user equipment is a first-category reference signal.

In some embodiments, receiving the indication information from the first network device includes: receiving RRM measurement configuration information from the first network device, where the RRM measurement configuration information includes the indication information.

In some embodiments, the to-be-measured reference signal is SSB or CSI-RS.

At step S502, configuration information is received from the first network device.

The configuration information is configured for configuring measurement and reporting of event trigger category, and an event corresponding to the event trigger category is correlated with at least one of a measurement result of a first-category reference signal and a measurement result of a second-category reference signal of the neighboring cell.

At step S503, when occurrence of an event corresponding to the configuration information is determined, a measurement result is reported.

An embodiment of the present disclosure provides a method for transmitting measurement configuration information, which is performed by a first network device. FIG. 6 is a flowchart illustrating a method of transmitting a reference signal measurement result according to an exemplary embodiment of the present disclosure. As shown in FIG. 6, the method includes step S601.

At step S601, configuration information is transmitted to a user equipment.

The configuration information is configured for configuring measurement and reporting of event trigger category, and an event corresponding to the event trigger category is correlated with at least one of a measurement result of a first-category reference signal and a measurement result of a second-category reference signal of a neighboring cell.

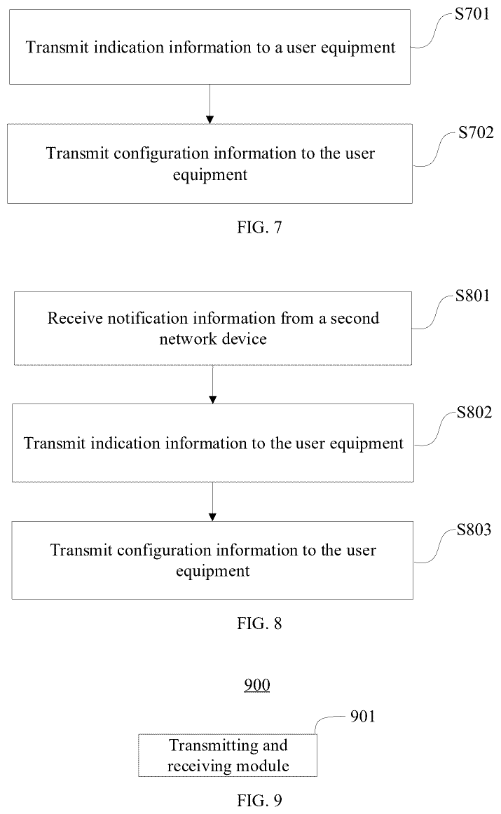

An embodiment of the present disclosure provides a method for transmitting measurement configuration information, which is performed by a first network device. FIG. 7 is a flowchart illustrating a method of transmitting a reference signal measurement result according to an exemplary embodiment of the present disclosure. As shown in FIG. 7, the method includes steps S701 to S702.

At step S701, indication information is transmitted to a user equipment.

The indication information is configured to indicate whether a to-be-measured reference signal of a neighboring cell of a user equipment is a first-category reference signal.

In some embodiments, transmitting the indication information to the user equipment includes: transmitting RRM measurement configuration information to the user equipment, where the RRM measurement configuration information includes the indication information.

In some embodiments, the to-be-measured reference signal is SSB or CSI-RS.

At step S702, configuration information is transmitted to the user equipment.

The configuration information is configured for configuring measurement and reporting of event trigger category, and an event corresponding to the event trigger category is correlated with at least one of a measurement result of a first-category reference signal and a measurement result of a second-category reference signal of the neighboring cell.

An embodiment of the present disclosure provides a method for transmitting measurement configuration information, which is performed by a first network device. FIG. 8 is a flowchart illustrating a method of transmitting a reference signal measurement result according to an exemplary embodiment of the present disclosure. As shown in FIG. 8, the method includes steps S801 to S803.

At step S801, notification information is received from a second network device.

The notification information is configured to indicate whether a to-be-measured reference signal transmitted by the second network device for RRM-measurement by a user equipment in a cell corresponding to the first network device is a first-category reference signal. In some embodiments, the to-be-measured reference signal is SSB or CSI-RS.

After receiving the notification information, the first network device can determine whether the to-be-measured reference signal transmitted by the second network device for RRM-measurement by the user equipment in the cell corresponding to the first network device is the first-category reference signal. A neighboring cell of the user equipment is a cell under the second network device, and a cell under the first network device to which the user equipment belongs is a service cell.

At step S802, indication information is transmitted to the user equipment.

The indication information is configured to indicate whether a to-be-measured reference signal of the neighboring cell of the user equipment is the first-category reference signal.

In some embodiments, transmitting the indication information to the user equipment includes: transmitting RRM measurement configuration information to the user equipment, where the RRM measurement configuration information includes the indication information.

In some embodiments, the to-be-measured reference signal is SSB or CSI-RS.

At step S803, configuration information is transmitted to the user equipment.

The configuration information is configured for configuring measurement and reporting of event trigger category, and an event corresponding to the event trigger category is correlated with at least one of a measurement result of a first-category reference signal and a measurement result of a second-category reference signal of the neighboring cell.

Based on the same idea as the method embodiments, an embodiment of the present disclosure further provides a communication apparatus. The communication apparatus may have the functions of the user equipment 101 in the method embodiments to perform the steps performed by the user equipment 101 in the embodiments. The functions may be implemented by hardware or by software or by implementing software through hardware. The hardware or software may include one or more modules corresponding to the functions.

In one possible implementation, the communication apparatus 900 shown in FIG. 9 may be used as the user equipment 101 in the method embodiments to perform the steps performed by the user equipment 101 in any one of the method embodiments.

The communication apparatus 900 includes a transmitting and receiving module 901.

The transmitting and receiving module 901 is configured to receive configuration information from a first network device, where the configuration information is configured for configuring measurement and reporting of event trigger category, an event corresponding to the event trigger category is correlated with at least one of a measurement result of a first-category reference signal and a measurement result of a second-category reference signal of a neighboring cell, the first-category reference signal is a disable-able reference signal and the second-category reference signal is a non-disable-able reference signal.

In some embodiments, the event is at least one of the following:
the measurement result of the second-category reference signal of the neighboring cell is better than a measurement result of a reference signal of a primary cell or primary-secondary cell, and a difference between the measurement results is greater than a first offset; the measurement result of the second-category reference signal of the neighboring cell is better than a first threshold; a measurement result of a reference signal of a service cell is worse than a second threshold, and the measurement result of the second-category reference signal of the neighboring cell is better than a third threshold; the measurement result of the second-category reference signal of the neighboring cell is better than a measurement result of a reference signal of a secondary cell, and a difference between the measurement results is greater than a second offset; the measurement result of the first-category reference signal of the neighboring cell and the measurement result of the second-category reference signal of the neighboring cell are both better than a fourth threshold.

In some embodiments, the transmitting and receiving module 901 is further configured to receive indication information from the first network device, where the indication information is configured to indicate whether a to-be-measured reference signal of the neighboring cell is the first-category reference signal.

In some embodiments, the transmitting and receiving module 901 is further configured to receive Radio Resource Management (RRM) measurement configuration information from the first network device, where the RRM measurement configuration information includes the indication information.

In some embodiments, the to-be-measured reference signal is Synchronization Signal Block (SSB) or Channel State Information-Reference Signal (CSI-RS).

In some embodiments, the transmitting and receiving module 901 is further configured to report a measurement result in response to occurrence of an event corresponding to the configuration information.

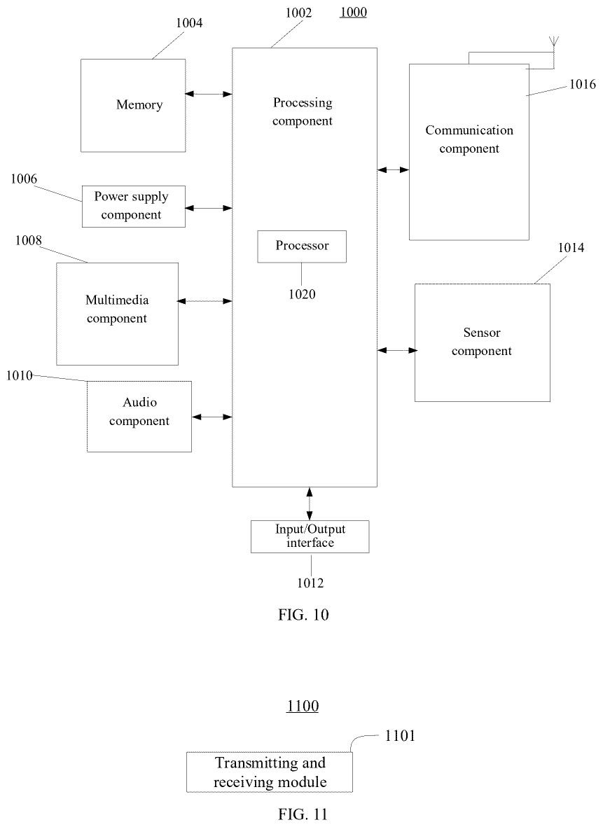

When the communication apparatus is the user equipment 101, its structure can also be as shown in FIG. 10.

FIG. 10 is a block diagram of an apparatus 1000 according to an exemplary embodiment of the present disclosure. For example, the apparatus 1000 may be a mobile phone, a computer, a digital broadcast terminal, a message transceiver, a game console, a tablet device, a medical device, a fitness device, a personal digital assistant, and the like.

As shown in FIG. 10, the apparatus 1000 may include one or more of the following components: a processing component 1002, a memory 1004, a power supply component 1006, a multimedia component 1008, an audio component 1010, an input/output (I/O) interface 1012, a sensor component 1014 and a communication component 1016.

The processing component 1002 generally controls overall operations of the apparatus 1000, such as operations associated with display, phone calls, data communications, camera operations, and recording operations. The processing component 1002 may include one or more processors 1020 to execute instructions to complete all or part of the steps of the methods. In addition, the processing component 1002 may include one or more modules which facilitate the interaction between the processing component 1002 and other components. For example, the processing component 1002 may include a multimedia module to facilitate the interaction between the multimedia component 1008 and the processing component 1002.

The memory 1004 is configured to store various types of data to support the operation of the apparatus 1000. Examples of such data include instructions for any application or method operated on the apparatus 1000, contact data, phonebook data, messages, pictures, videos, and so on. The memory 1004 may be implemented by any category of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 1006 supplies power for different components of the apparatus 1000. The power supply component 1006 may include a power supply management system, one or more power supplies, and other components associated with generating, managing and distributing power for the apparatus 1000.

The multimedia component 1008 includes a screen that provides an output interface between the apparatus 1000 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 1008 includes a front camera and/or a rear camera. When the apparatus 1000 is in an operation mode, such as a shooting mode or a video mode, the front camera and/or the rear camera may receive external multimedia data. Each of the front and rear cameras may be a fixed optical lens system or have a focal length and an optical zoom capability.

The audio component 1010 is configured to output and/or input audio signals. For example, the audio component 1010 includes a microphone (MIC) configured to receive an external audio signal when the apparatus 1000 is in an operation mode, such as a call mode, a recording mode, and a voice recognition mode. The received audio signal may be further stored in the memory 1004 or transmitted via the communication component 1016. In some examples, the audio component 1010 also includes a loudspeaker for outputting an audio signal.

The I/O interface 1012 provides an interface between the processing component 1002 and a peripheral interface module which may be a keyboard, a click wheel, a button, or the like. These buttons may include, but are not limited to a home button, a volume button, a start button, and a lock button.

The sensor component 1014 includes one or more sensors for providing a status assessment in various aspects for the apparatus 1000. For example, the sensor component 814 may detect an open/closed state of the apparatus 1000, and the relative positioning of components, for example, the component is a display and a keypad of the apparatus 1000. The sensor component 1014 may also detect a change in position of the apparatus 1000 or a component of the apparatus 1000, the presence or absence of a user in contact with the apparatus 1000, the orientation or acceleration/deceleration of the apparatus 1000 and a change in temperature of the apparatus 1000. The sensor component 1014 may include a proximity sensor configured to detect the presence of nearby objects without any physical contact. The sensor component 1014 may also include a light sensor, such as a CMOS or CCD image sensor, for use in imaging applications. In some examples, the sensor component 1014 may also include an acceleration sensor, a gyro sensor, a magnetic sensor, a pressure sensor, or a temperature sensor.

The communication component 1016 is configured to facilitate wired or wireless communication between the apparatus 1000 and other devices. The apparatus 1000 may access a wireless network based on a communication standard, such as WiFi, 4G or 5G, or a combination thereof. In an example, the communication component 1016 receives broadcast signals or broadcast associated information from an external broadcast management system via a broadcast channel. In an example, the communication component 1016 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the apparatus 1000 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic elements for performing the methods.

In an example, there is also provided a non-transitory computer readable storage medium including instructions, such as a memory 1004 including instructions, where the instructions are executable by the processor 1020 of the apparatus 1000 to perform the method as described. The non-transitory compute readable storage medium may be a Read Only Memory (ROM), a Random Access Memory (RAM), a CD-ROM, a magnetic tape, a floppy disk and an optical data storage device and the like.

Based on the same idea as the method embodiments, an embodiment of the present disclosure further provides a communication apparatus. The communication apparatus can have the functions of the network device 102 in the method embodiments, and can be configured to perform the steps performed by the network device 102 in the method embodiments. The functions can be implemented by hardware or by software or by implementing corresponding software through hardware. The hardware or software includes one or more modules corresponding to the functions.

In one possible implementation, the communication apparatus 1100 shown in FIG. 11 may be used as the network device 102 in the method embodiments and perform the steps performed by the network device 102 in the method embodiments.

The communication apparatus 1100 includes a transmitting and receiving module 1101.

The transmitting and receiving module 1101 is configured to transmit configuration information to a user equipment, where the configuration information is configured for configuring measurement and reporting of event trigger category, and an event corresponding to the event trigger category is correlated with at least one of a measurement result of a first-category reference signal and a measurement result of a second-category reference signal of a neighboring cell; the first-category reference signal is a disable-able reference signal and the second-category reference signal is a non-disable-able reference signal.

In some embodiments, the event may be at least one of the following:
the measurement result of the second-category reference signal of the neighboring cell is better than a measurement result of a reference signal of a primary cell or primary-secondary cell, and a difference between the measurement results is greater than a first offset; the measurement result of the second-category reference signal of the neighboring cell is better than a first threshold; a measurement result of a reference signal of a service cell is worse than a second threshold, and the measurement result of the second-category reference signal of the neighboring cell is better than a third threshold; the measurement result of the second-category reference signal of the neighboring cell is better than a measurement result of a reference signal of a secondary cell, and a difference between the measurement results is greater than a second offset; or the measurement result of the first-category reference signal of the neighboring cell and the measurement result of the second-category reference signal of the neighboring cell are both better than a fourth threshold.

In some embodiments, the transmitting and receiving module 1101 is further configured to transmit indication information to the user equipment, where the indication information is configured to indicate whether a to-be-measured reference signal of the neighboring cell is the first-category reference signal.

In some embodiments, the transmitting and receiving module 1101 is further configured to transmit Radio Resource Management (RRM) measurement configuration information to the user equipment, wherein the RRM measurement configuration information includes the indication information.

In some embodiments, the transmitting and receiving module 1101 is further configured to receive notification information from a second network device, where the notification information is configured to indicate whether a to-be-measured reference signal transmitted by the second network device for RRM-measurement by the user equipment in a cell corresponding to the first network device is the first-category reference signal.

In some embodiments, the to-be-measured reference signal is a Synchronization Signal Block (SSB) or Channel State Information-Reference signal (CSI-RS).

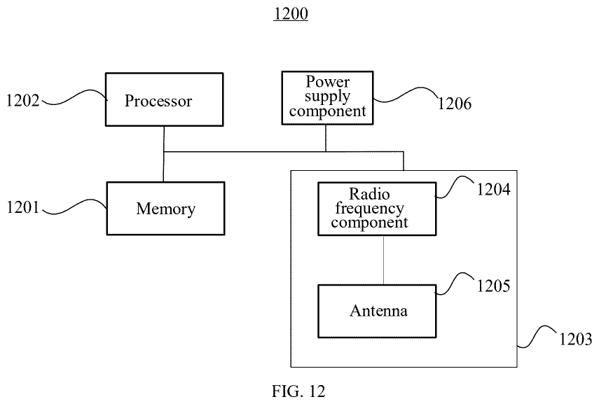

When the communication apparatus is the network device 102, its structure can also be as shown in FIG. 12. As shown in FIG. 12, the apparatus 1200 includes a memory 1201, a processor 1202, a transmitting and receiving component 1203, and a power supply component 1206. The memory 1201 is coupled with the processor 1202 and can be configured to store programs and data necessary for the communication apparatus 1200 to perform various functions. The processor 1202 is configured to support the communication apparatus 1200 to perform the corresponding functions in the methods. The functions can be implemented by invoking programs in the memory 1201. The transmitting and receiving component 1203 may be a wireless transceiver which can be configured to support the communication apparatus 1200 to receive signaling and/or data and transmit signaling and/or data via wireless air interface. The transmitting and receiving component 1203 can also be referred to as transmitting and receiving unit or communication unit. The transmitting and receiving component 1203 may include a radio frequency component 1204 and one or more antennas 1205. The radio frequency component 1204 may be a remote radio unit (RRU), which specifically may be configured for transmission of radio signals and conversion between radio signal and baseband signal. The one or more antennas 1205 are specifically configured for radiation and reception of radio signals.

When the communication apparatus 1200 needs to transmit data, the processor 1202 can perform baseband processing on the to-be-sent data and then output baseband signals to the radio unit, and the radio unit can perform radio processing on the baseband signals and then transmit the radio signals in the form of electromagnetic wave via the antennas. When there is data to be transmitted to the communication apparatus 1200, the radio unit can receive radio signals via the antennas and convert the radio signals into baseband signals and output the baseband signals to the processor 1202, and the processor 1202 can convert the baseband signals into data and process the data.

In the present disclosure, compared with the solution in which a corresponding measurement result is reported when any to-be-measured reference signal satisfies the trigger event without determining whether the to-be-measured reference signal is the first-category reference signal, considering when the to-be-measured reference signal of the neighboring cell is the first-category reference signal, the beam corresponding to the to-be-measured reference signal may be dynamically disabled instead of preferentially switching target, there is less meaning of reporting a corresponding measurement result due to the trigger of the measurement result of the first-category reference signal satisfying the trigger event requirement. By determining the to-be-measured reference signal of the neighboring cell is the first-category reference signal or the second-category reference signal and configuring measurement and reporting of the event trigger category to correlate the event corresponding to the event trigger category with the measurement result of the first-category reference signal and/or the measurement result of the second-category reference signal, unnecessary reporting can be avoided in the circumstance that only the measurement result of the first-category reference signal satisfies the trigger event and the measurement result of the second-category reference signal does not satisfy the trigger event, making the reporting of the measurement result more reasonable and effective.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure indicated by the following claims.

It should be understood that the present disclosure is not limited to the precise structure described and shown in the accompanying drawings, and that various modifications and changes may be made without departing from the scope thereof. The scope of the present disclosure is limited only by the appended claims.

### INDUSTRIAL APPLICABILITY

Compared with the solution in which a corresponding measurement result is reported when any to-be-measured reference signal satisfies the trigger event without determining whether the to-be-measured reference signal is the first-category reference signal, considering when the to-be-measured reference signal of the neighboring cell is the first-category reference signal, the beam corresponding to the to-be-measured reference signal may be dynamically disabled instead of preferentially switching target, there is less meaning of reporting a corresponding measurement result due to the trigger of the measurement result of the first-category reference signal satisfying the trigger event requirement. By determining the to-be-measured reference signal of the neighboring cell is the first-category reference signal or the second-category reference signal and configuring measurement and reporting of the event trigger category to correlate the event corresponding to the event trigger category with the measurement result of the first-category reference signal and/or the measurement result of the second-category reference signal, unnecessary reporting can be avoided in the circumstance that only the measurement result of the first-category reference signal satisfies the trigger event and the measurement result of the second-category reference signal does not satisfy the trigger event, making the reporting of the measurement result more reasonable and effective.

1. A method for receiving measurement configuration information, performed by a user equipment and comprising:
receiving configuration information from a first network device, wherein the configuration information is configured for configuring measurement and reporting of event trigger category, an event corresponding to the event trigger category is correlated with at least one of: a measurement result of a first-category reference signal of a neighboring cell or a measurement result of a second-category reference signal of the neighboring cell, the first-category reference signal is a disable-able reference signal, and the second-category reference signal is a non-disable-able reference signal.

2. The method of claim 1, wherein the event is at least one of that:
the measurement result of the second-category reference signal of the neighboring cell is better than a measurement result of a reference signal of a primary cell or primary-secondary cell, and a difference between the measurement results is greater than a first offset;
the measurement result of the second-category reference signal of the neighboring cell is better than a first threshold;
a measurement result of a reference signal of a service cell is worse than a second threshold, and the measurement result of the second-category reference signal of the neighboring cell is better than a third threshold;
the measurement result of the second-category reference signal of the neighboring cell is better than a measurement result of a reference signal of a secondary cell, and a difference between the measurement results is greater than a second offset; or
the measurement result of the first-category reference signal of the neighboring cell and the measurement result of the second-category reference signal of the neighboring cell are both better than a fourth threshold.

3. The method of claim 1, further comprising:
receiving indication information from the first network device, wherein the indication information is configured to indicate whether a to-be-measured reference signal of the neighboring cell is the first-category reference signal.

4. The method of claim 3, wherein receiving the indication information from the first network device comprises:
receiving radio resource management (RRM) measurement configuration information from the first network device, wherein the RRM measurement configuration information comprises the indication information.

5. The method of claim 3, wherein the to-be-measured reference signal is a synchronization signal block (SSB) or a channel state information-reference signal (CSI-RS).

6. A method for transmitting measurement configuration information, performed by a first network device and comprising:
transmitting configuration information to a user equipment, wherein the configuration information is configured for configuring measurement and reporting of event trigger category, an event corresponding to the event trigger category is correlated with at least one of: a measurement result of a first-category reference signal of a neighboring cell or a measurement result of a second-category reference signal of the neighboring cell, the first-category reference signal is a disable-able reference signal, and the second-category reference signal is a non-disable-able reference signal.

7. The method of claim 6, wherein the event is at least one of that:
the measurement result of the second-category reference signal of the neighboring cell is better than a measurement result of a reference signal of a primary cell or primary-secondary cell, and a difference between the measurement results is greater than a first offset;
the measurement result of the second-category reference signal of the neighboring cell is better than a first threshold;
a measurement result of a reference signal of a service cell is worse than a second threshold, and the measurement result of the second-category reference signal of the neighboring cell is better than a third threshold;
the measurement result of the second-category reference signal of the neighboring cell is better than a measurement result of a reference signal of a secondary cell, and a difference between the measurement results is greater than a second offset; or
the measurement result of the first-category reference signal of the neighboring cell and the measurement result of the second-category reference signal of the neighboring cell are both better than a fourth threshold.

8. The method of claim 6, further comprising:
transmitting indication information to the user equipment, wherein the indication information is configured to indicate whether a to-be-measured reference signal of the neighboring cell is the first-category reference signal.

9. The method of claim 8, wherein transmitting the indication information to the user equipment comprises:
transmitting radio resource management (RRM) measurement configuration information to the user equipment, wherein the RRM measurement configuration information comprises the indication information.

10. The method of claim 8, further comprising:
receiving notification information from a second network device, wherein the notification information is configured to indicate whether a to-be-measured reference signal, transmitted by the second network device, for RRM-measurement by a user equipment in a cell corresponding to the first network device is the first-category reference signal.

11. The method of claim 8, wherein the to-be-measured reference signal is a synchronization signal block (SSB) or a channel state information-reference signal (CSI-RS).

12-13. (canceled)

14. An electronic device, comprising a processor and a memory, wherein,
the memory is configured to store computer programs;
the processor is configured to execute the computer programs to perform operations comprising:
receiving configuration information from a first network device, wherein the configuration information is configured for configuring measurement and reporting of event trigger category, an event corresponding to the event trigger category is correlated with at least one of: a measurement result of a first-category reference signal of a neighboring cell or a measurement result of a second-category reference signal of the neighboring cell, the first-category reference signal is a disable-able reference signal, and the second-category reference signal is a non-disable-able reference signal.

15. An electronic device, comprising a processor and a memory, wherein,
the memory is configured to store computer programs;
the processor is configured to execute the computer programs to perform the method of claim 6.

16. A non-transitory computer readable storage medium, storing instructions thereon, wherein the instructions, when executed by a processor, cause the processor to perform the method of claim 1.

17. A non-transitory computer readable storage medium, storing instructions thereon, wherein the instructions, when executed by a processor, cause the processor to perform the method of claim 6.

18. The electronic device of claim 14, wherein the event is at least one of that:
the measurement result of the second-category reference signal of the neighboring cell is better than a measurement result of a reference signal of a primary cell or primary-secondary cell, and a difference between the measurement results is greater than a first offset;
the measurement result of the second-category reference signal of the neighboring cell is better than a first threshold;
a measurement result of a reference signal of a service cell is worse than a second threshold, and the measurement result of the second-category reference signal of the neighboring cell is better than a third threshold;
the measurement result of the second-category reference signal of the neighboring cell is better than a measurement result of a reference signal of a secondary cell, and a difference between the measurement results is greater than a second offset; or
the measurement result of the first-category reference signal of the neighboring cell and the measurement result of the second-category reference signal of the neighboring cell are both better than a fourth threshold.

19. The electronic device of claim 14, wherein the operations further comprises:
receiving indication information from the first network device, wherein the indication information is configured to indicate whether a to-be-measured reference signal of the neighboring cell is the first-category reference signal.

20. The electronic device of claim 19, wherein receiving the indication information from the first network device comprises:
receiving radio resource management (RRM) measurement configuration information from the first network device, wherein the RRM measurement configuration information comprises the indication information.

21. The electronic device of claim 19, wherein the to-be-measured reference signal is a synchronization signal block (SSB) or a channel state information-reference signal (CSI-RS).
